(19) United States
(12) Patent Application Publication
(10) Pub. No.: US 2021/0095991 A1
(43) Pub. Date: Apr. 1, 2021

(54) VEHICLE TRAVELING CONDITION EVALUATION METHOD AND SYSTEM

(71) Applicant: TOYO TIRE CORPORATION, Itami-shi (JP)

(72) Inventor: Koji Arakawa, Itami-shi (JP)

(73) Assignee: TOYO TIRE CORPORATION, Itami-shi (JP)

(21) Appl. No.: 16/992,548

(22) Filed: Aug. 13, 2020

(30) Foreign Application Priority Data
Sep. 30, 2019 (JP) 2019-179950

(51) Int. Cl. G01C 21/00; G01C 21/36; G01C 21/34

(52) U.S. Cl. CPC G01C 21/387; G06T 11/20; G01C 21/3461; G01C 21/3626

(57) ABSTRACT

A vehicle traveling condition evaluation method comprising: dividing stored map information into a plurality of sectioned areas; associating position information indicating a position of a vehicle with traveling information indicating traveling of the vehicle; storing the information obtained in the associating; calculating an index value of the traveling information for each of the plurality of sectioned area based on the information accumulated in the storing; and displaying the index value calculated in the calculating as traveling severity in an identifiable manner on a map displayed on a screen for each of the plurality of sectioned areas.

### CROSS-REFERENCE TO RELATED APPLICATIONS

This application claims priority of Japanese Patent Application No.: 2019-179950 filed on Sep. 30 2019, the content of which is incorporated herein by reference.

### BACKGROUND OF THE INVENTION

### Technical Field

The present invention relates to a vehicle traveling condition evaluation method and a vehicle traveling condition evaluation system.

### Related Art

There is conventionally known a wear resistance performance evaluation method which measures acceleration of a vehicle, and calculates traveling severity (driving severity number: DSN) as a tire wear resistance performance evaluation index based on the measured acceleration (for example, Patent Document 1).

However, JP 2010-204095 A considers only acceleration as the traveling severity. Moreover, JP 2010-204095 A does not consider how the traveling severity changes with variations of a traveling place of the vehicle.

### SUMMARY

An object of the present invention is to provide a vehicle traveling condition evaluation method and a vehicle traveling condition evaluation system capable of improving evaluation accuracy and visualizing the evaluation accuracy by evaluating traveling severity in accordance with variations of a traveling place.

As a means for achieving the above object, the present invention provides a vehicle traveling condition evaluation method including: a first step of dividing stored map information into a plurality of sectioned areas; a second step of associating position information indicating a position of a vehicle with traveling information indicating traveling of the vehicle; a third step of storing information obtained in the second step; a fourth step of calculating an index value of the traveling information for each of the plurality of sectioned area based on information accumulated in the third step; and a fifth step of displaying the index value calculated in the fourth step as traveling severity in an identifiable manner on a map displayed on a screen for each of the plurality of sectioned areas.

This method achieves storage of the traveling information associated with the vehicle for each of the plurality of sectioned areas, and identifiable display of the traveling severity on the map based on the index value of the accumulated traveling information for each of the plurality of sectioned areas. In this manner, the traveling severity is recognizable at a glance. In addition, evaluation accuracy can be raised by finely setting the plurality of sectioned areas. Moreover, the obtained information is available for various purposes such as estimation of a tire wear state.

It is preferable that, in the first step, each of the plurality of sectioned areas is configured to be set to any area. It is preferable that, in the fourth step, the index value of the traveling information is configured to be calculated for each of the plurality of sectioned areas which are set in the first step.

In this case, each of the plurality of sectioned areas can be set to an appropriate range as necessary.

It is preferable that, in the fifth step, the index value of the traveling information calculated for each of the plurality of sectioned areas in the fourth step is identifiably displayed as the traveling severity on a road contained in the map displayed on the screen.

In this case, the traveling severity can be identifiably displayed on the road where the vehicle is traveling based on the index value of the traveling information. Accordingly, the traveling severity is easily viewable and recognizable.

It is preferable that, in the first step, the plurality of sectioned areas are managed for each country.

In this case, road conditions and law differences for each country can be taken into consideration.

It is preferable that, in the first step, an index value in a setting range larger than each of the plurality of sectioned areas is calculated based on the index value for each of all the plurality of sectioned areas included in the setting range.

In this case, the index value can be calculated for a setting range determined in any manners only by accumulating information for each of the plurality of sectioned areas.

It is preferable that, in the fourth step, the index value is corrected based on traveling-related information indicating a traveling-related matter that affect tire wear as a result of traveling of the vehicle.

In this case, display becomes more appropriate display suited for actual circumstances by correcting the index value based on the traveling-related information such as an air temperature and a weather. Accordingly, estimation accuracy of the tire wear state and the like can be improved.

As a means for achieving the above object, the present invention provides a vehicle traveling condition evaluation system including: a reception unit that detects position information indicating a position of a vehicle; a measurement unit that measures traveling information indicating traveling of the vehicle; a storage unit that stores map information, a plurality of sectioned areas obtained by dividing a map displayed on a screen based on the map information, and the position information and the traveling information associated with each other; a display unit that displays a map based on the map information stored in the storage unit; and a processing unit that calculates an index value for each of the plurality of sectioned areas based on the position information and the traveling information stored in the storage unit, and causes the display unit to display the calculated index value as traveling severity in the map displayed on the display unit based on the position information detected by the reception unit.

According to this configuration, the position information associated with the vehicle and the traveling information associated with the vehicle are stored in the storage unit in association with each other for each of the plurality of sectioned areas, and the traveling information is indexed. In this case, the traveling severity can be identifiably displayed with ease in the map on the screen displayed on the display unit. In addition, evaluation accuracy can be raised by finely setting the plurality of sectioned areas.

According to the present invention, traveling information is stored in association with position information, and an index value for each of sectioned areas on a map is calculated. In this manner, traveling severity can be identifiably displayed on the map displayed on a screen. Accordingly, the vehicle traveling information is recognizable at a glance. In addition, evaluation accuracy can be raised by finely setting the plurality of sectioned areas.

### BRIEF DESCRIPTION OF THE DRAWINGS

The foregoing and the other features of the present invention will become apparent from the following description and drawings of an illustrative embodiment of the invention in which:

FIG. 1 is a block diagram of a vehicle traveling condition evaluation system according to the present embodiment;

FIG. 2 is a plan view showing a map displayed on a second display unit of FIG. 1;

FIG. 3 is an enlarged partial view of FIG. 2;

FIG. 4 is a plan view showing FIG. 3 in a different manner; and

FIG. 5 is a block diagram of a vehicle traveling condition evaluation system in a modified example.

### DETAILED DESCRIPTION OF EMBODIMENTS

An embodiment according to the present invention is hereinafter described with reference to the accompanying drawings.

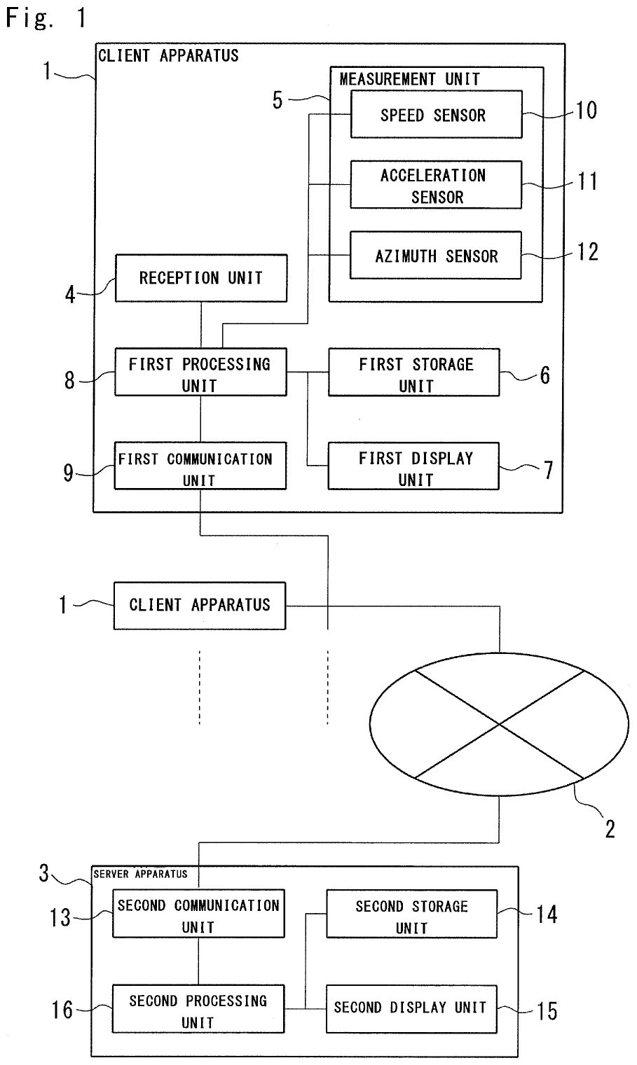

FIG. 1 shows a vehicle traveling condition evaluation system according to the present embodiment. This system includes a client apparatus 1 constituted by various electronic devices provided on each vehicle, and a server apparatus 3 connected via a communication network 2 such as the Internet.

The client apparatus 1 includes a reception unit 4, a measurement unit 5, a first storage unit 6, a first display unit 7, a first processing unit 8, a first communication unit 9, and the like.

The reception unit 4 receives a signal transmitted from a global positioning system (GPS) satellite, performs processing such as decoding of the received signal, and outputs the processed signal to the first processing unit 8. The reception unit 4 is a unit for acquiring position information associated with a vehicle.

The measurement unit 5 includes a speed sensor 10, an acceleration sensor 11, an azimuth sensor 12, and the like for detecting vehicle traveling information associated with the vehicle.

The speed sensor 10 may be constituted by a sensor which outputs a pulse signal in accordance with a rotation speed of wheels.

The acceleration sensor 11 may be of any type such as a capacitance detection type, a piezo resistance type, and a heat detection type. The sensor to be provided is preferably not only a sensor for detecting acceleration of the vehicle in a front-rear direction, but also a sensor for detecting acceleration in a left-right direction. A sensor for detecting acceleration of the vehicle in an up-down direction may be provided as necessary.

The azimuth sensor 12 is a sensor which detects an azimuth where the vehicle is traveling, and calculates an azimuth angle by a known method based on an angular speed detected by an optical gyro sensor such as a mechanical gyro sensor and a ring laser gyro, for example, and angular acceleration detected by an angular acceleration sensor. The azimuth sensor 12 is used in cooperation with the speed sensor 10 to correct position information when information received by the reception unit 4 from GPS is insufficient.

The measurement unit 5 also includes a sensor for detecting traveling-related information indicating traveling-related matters that affect tire wear as a result of traveling of the vehicle. The traveling-related information includes information associated with tire wear caused by differences in road surface conditions such as road surface roughness, a road surface type (a dry road surface, a wet road surface, a snow surface, and an ice road surface), and a road temperature, and environmental conditions such as an air temperature, humidity, a season, and a climate.

For example, a sensor for acquiring the road surface type includes a rain sensor, and a rotation angle sensor for detecting an operation speed of wipers. A rainfall amount can be directly detected by the rain sensor. The rainfall amount can be estimated from the operation speed of the wipers detected by the rotation angle sensor. The road surface type can be estimated from the rainfall amount thus obtained. In addition to detection by these sensors, information obtained via the Internet, such as information from AMeDAS (Automated Meteorological Data Acquisition System), is available to obtain a rainfall amount at a traveling place of the vehicle and estimate a road surface type. A sensor for acquiring an air temperature includes an outside air sensor mounted on the vehicle for detecting an outside air temperature, for example. Other traveling-related information can also be acquired based on other sensors or information available via the Internet.

The tire wear amount predicted in accordance with the vehicle traveling information described above is corrected herein based on the obtained traveling-related information. For example, it is assumable that tire wear rather decreases in a rainy weather which makes a road surface slippery. In a case of a snow weather which makes the road surface more slippery, it is assumable that tire wear further decreases. It is also known that tire wear performance changes in accordance with a temperature change. Therefore, a tire wear amount calculated from the traveling information is corrected based on the obtained traveling-related information. For example, a tire wear amount of a certain tire under a certain traveling condition can be accurately estimated by determining a correction coefficient based on a relationship between a tire wear amount and traveling-related information obtained by an experiment or the like performed for the tire.

The first storage unit 6 stores map information, and may be constituted by a hard disk device or a magneto-optical disk device, a nonvolatile memory such as a flash memory (a read-only storage medium such as a CD-ROM), a volatile memory such as a random access memory (RAM), or a combination of these.

The first storage unit 6 stores beforehand the map information divided into a plurality of sectioned areas (first step). Each shape of the sectioned areas is not limited to a square, but may be various shapes such as a rectangle, a triangle, a hexagon, and an octagon allowed to be equally divided. For example, each of the sectioned areas may be a square which is 1 km long for each side, and may be designated as a minimum unit. Moreover, each shape of the sectioned areas is not limited to any of these shapes, but may be a free shape such as a cloud shape. Furthermore, the sectioned areas are not all required to have a uniform shape, but may have shapes each selected from a combination of various shapes. In addition, the first storage unit 6 stores the vehicle traveling information in association with each sectioned area as described below.

The first display unit 7 is a unit for displaying an image such as a map, and is constituted by a touch panel display or the like. The map displayed on a screen can be freely enlarged, reduced, and moved.

The first processing unit 8 includes a central processing unit (CPU), and is connected to the reception unit 4, the speed sensor 10, the acceleration sensor 11, the azimuth sensor 12, the first display unit 7, the first communication unit 9, and the like via an input/output (I/O) port or a communication network.

The first processing unit 8 executes a program stored in the first storage unit 6 based on a signal input from the reception unit 4 to identify a current position of the vehicle. Moreover, the first processing unit 8 causes the first display unit 7 to display the current position of the vehicle and a map around the vehicle. The first processing unit 8 further associates the current position of the vehicle with the vehicle traveling information obtained by the measurement unit 5 (second step), and causes the first storage unit 6 to store the current position and the vehicle traveling information for each of the sectioned areas.

The first communication unit 9 transmits vehicle information obtained by the reception unit 4 and the measurement unit 5 and stored in the first storage unit 6 to the server apparatus 3 via the communication network 2.

These electronic devices may be constituted by existing electronic devices provided on the vehicle, or may be constituted by electronic devices separately mounted. Alternatively, a portable device allowed to be carried into the vehicle, such as a smartphone, may be used.

The server apparatus 3 includes a second communication unit 13, a second storage unit 14, a second display unit 15, a second processing unit 16, and the like.

The second communication unit 13 receives information transmitted from the first communication unit 9 on the vehicle side via the communication network 2. In addition, a result obtained by executing the program in a manner described below is transmitted to the first communication unit 9 on the vehicle side via the communication network 2.

The second storage unit 14 may have a configuration similar to the corresponding configuration on the vehicle side. The second storage unit 14 stores a computer program, and stores and accumulates as necessary vehicle traveling information and traveling-related information transmitted from each vehicle for each sectioned area.

Similarly to the first display unit 7, the second display unit 15 is constituted by a touch panel display or the like, and configured to display a map or the like. When displaying a map, the second display unit 15 can freely enlarge, reduce, and move the map in a similar manner.

The second processing unit 16 includes a CPU, and is connected to the second storage unit 14. The second processing unit 16 executes following processing under the program stored in the second storage unit 14.

Traveling information transmitted from each vehicle, that is, the client apparatus 1 is stored in the second storage unit 14 for each of the sectioned areas (third step). Traveling severity for each of the sectioned areas is calculated as an index value based on the traveling information stored in the second storage unit 14 (fourth step). The traveling information detected for each of the sectioned areas is indexed by root mean square (RMS) herein.

For indexing the information obtained by the speed sensor 10, the index value is calculated as follows. Running resistance RS increases as the number of rotations of a tire detected by the speed sensor 10 increases. When the running resistance RS increases, friction energy E increases accordingly. Accordingly, the friction energy E is calculated from a traveling distance D and a slip ratio S by E=RS×D×S. Thereafter, the calculated friction energy E is indexed by RMS. The index value thus obtained is available for predicting a tire wear amount. The tire wear amount increases in proportion to the magnitude of the friction energy E. Accordingly, the obtained index value can be considered as a value indicating the tire wear amount.

For indexing information obtained by the acceleration sensor 11, detected acceleration may be converted into friction energy per unit distance, and the obtained friction energy may be indexed by RMS. In this case, the obtained index value can be considered as the tire wear amount of the tire similarly to the above.

These processes may be performed not only by the second processing unit 16, but also by the first processing unit 8. In this case, a result calculated by the first processing unit 8 may be used by the second processing unit 16.

Indexing of the obtained information is not limited to indexing by RMS, but may be indexing by least squares, standard deviation, or the like.

After the traveling information is indexed, the index value is corrected based on the traveling-related information. More specifically, the obtained index value is corrected by multiplying the index value by a correction coefficient determined from the traveling-related information as described above. In this manner, the index value becomes a value more suitable for predicting a tire wear amount.

The index value for each sectioned area is calculated and corrected based on the traveling information and the traveling-related information, and is accumulated as described above. Thereafter, the index value is identifiably displayed as traveling severity for each setting range on the map displayed on the screen (fifth step).

The setting range can be freely changed. When the setting range has a size larger than the size of each of the sectioned areas, an average value may be calculated based on the index values of all the sectioned areas contained in the setting range, for example.

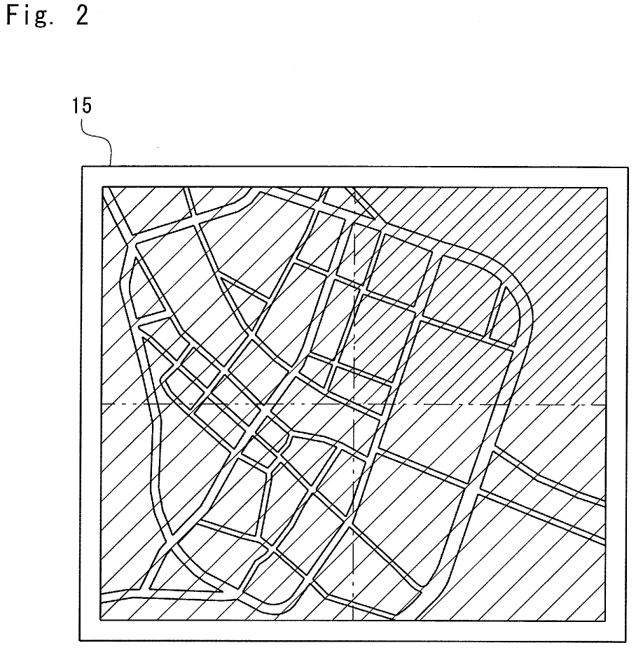

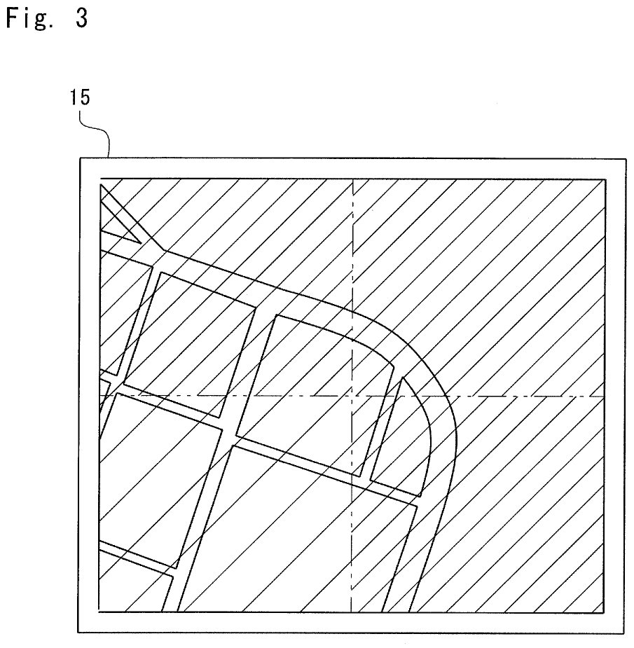

FIG. 2 is a wide-area map, while FIG. 3 is a partially enlarged detailed map of FIG. 2. In the detailed map, each setting range coincides with each sectioned area. Traveling severity is displayed in an identifiable manner for each setting range based on the calculated and corrected index value.

For example, the map has a background color of “red” or the like for a range where the index value is determined to be large, that is, in a range where the tire wear amount is determined to be large. The background color may be set to a lighter color, or a different color as the index value decreases. In the case of the background color gradually lightened, a difference between index values can be expressed by a difference in color gradations. In the case of the background changed to a different color, a plurality of ranges are set in accordance with variations in the index value (0 to 100, 100 to 200, etc.), and a different color is set for each range. Thereafter, the color displayed on the screen is changed in accordance with the range to which the index value of each sectioned area belongs. In FIG. 3, a gradation difference of the background color is expressed by a hatching interval difference.

When the map is reduced to display a wide area, the setting range may be automatically enlarged. In this case, the setting range includes a plurality of sectioned areas. Accordingly, index values of all of these sectioned areas may be averaged. Alternatively, the index value may be recalculated from all the traveling information within the setting range. In FIG. 2, each setting range includes a plurality of (four) sectioned areas, and traveling severity in the setting range is displayed in an identifiable manner based on an average value of index values of these sectioned areas. The background color is dark in the setting range with short hatching intervals. In this case, the index value is large. The background color becomes lighter as the hatching interval increases. In this case, the index value becomes smaller accordingly.

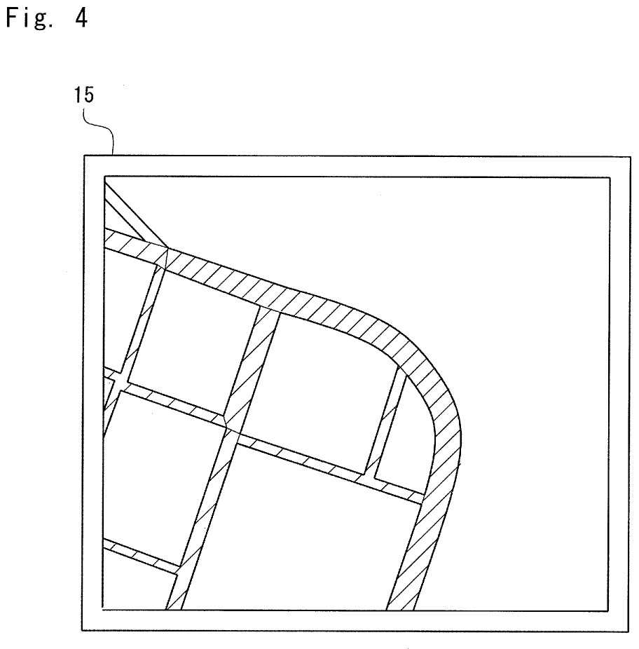

Traveling severity on the map may be also identifiably displayed in units of road. In FIG. 4, traveling severity is identifiably displayed in units of road. Similarly to the above, the color becomes darker as hatching intervals become shorter in the figure. In this case, the index value as traveling severity becomes larger.

The traveling information accumulated in the second storage unit 14 may be managed for each country. For example, road conditions in each country (road surface roughness, different road traffic laws, etc.) may be considered. Road surface roughness and the like greatly vary for each country. In this case, a tire wear state significantly differs even when a vehicle speed and acceleration are the same. Therefore, the correction coefficient for the traveling information may be varied for each country. Furthermore, the map displayed on the screen may be displayed by a method different for each country.

The present invention is not limited to the configuration described in the above embodiment, but may include various modifications.

According to the example described in the above embodiment, the tire wear amount is predicted based on the obtained traveling information. However, information other than this information may be predicted. For example, a tire uneven wear amount may be predicted based on information obtained in a case where the vehicle travels on a curve or the like.

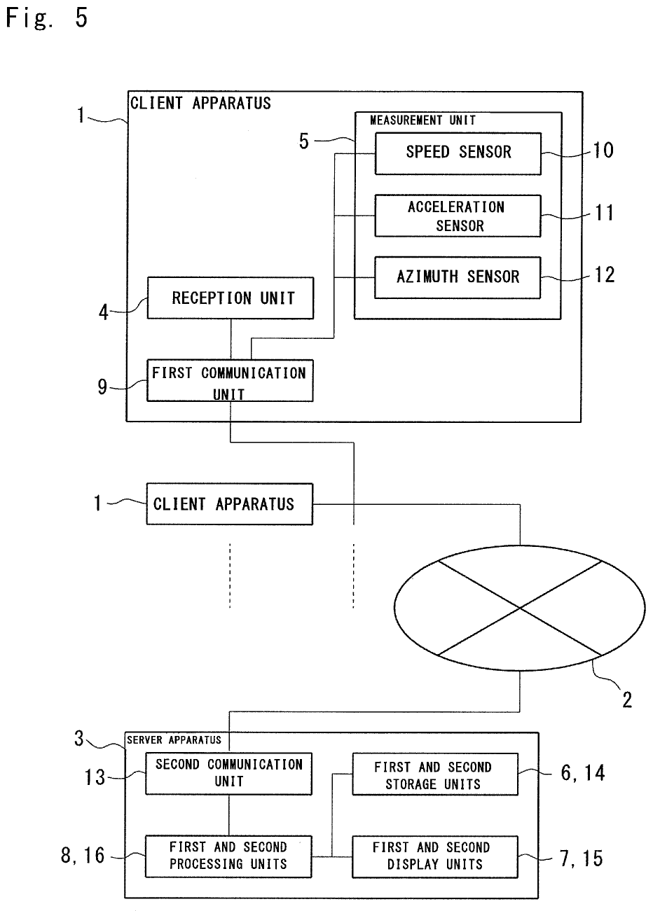

In addition, referring to FIG. 5, the client apparatus 1 may eliminate units other than the reception unit 4, the measurement unit 5, and the first communication unit 9 to reduce measuring functions to the minimum. In this case, the first storage unit 6, the first display unit 7, and the first processing unit 8 eliminated from the client apparatus 1 may be provided on the server apparatus 3.

In FIG. 5, each set of the first storage unit 6 and the second storage unit 14, the first display unit 7 and the second display unit 15, and the first processing unit 8 and the second processing unit 16 is expressed as the same block in the server apparatus 3. However, the present invention is not particularly limited to this mode. For example, a set of the first storage unit 6, the first display unit 7, and the first processing unit 8, and a set of the second storage unit 14, the second display unit 15, and the second processing unit 16 may be provided on different server apparatuses for each.

As shown in FIG. 5, size reduction of the client apparatus 1 is achievable by reducing the measuring functions to the minimum.

What is claimed is:

1. A vehicle traveling condition evaluation method comprising:
dividing stored map information into a plurality of sectioned areas;
associating position information indicating a position of a vehicle with traveling information indicating traveling of the vehicle;
storing the information obtained in the associating;
calculating an index value of the traveling information for each of the plurality of sectioned areas based on the information accumulated in the storing; and
displaying the index value calculated in the calculating as traveling severity in an identifiable manner on a map displayed on a screen for each of the plurality of sectioned areas.

2. The vehicle traveling condition evaluation method according to claim 1, wherein
in the dividing, each of the plurality of sectioned areas is configured to be set to any area, and
in the calculating, the index value of the traveling information is configured to be calculated for each of the plurality of sectioned areas which are set in the first step.

3. The vehicle traveling condition evaluation method according to claim 1, wherein, in the displaying, the index value of the traveling information calculated for each of the plurality of sectioned areas in the calculating is identifiably displayed as the traveling severity on a road contained in the map displayed on the screen.

4. The vehicle traveling condition evaluation method according to claim 1, wherein, in the dividing, the plurality of sectioned areas are managed for each country.

5. The vehicle traveling condition evaluation method according to claim 1, wherein, in the dividing, an index value for a setting range larger than each of the plurality of sectioned areas is calculated based on the index value for each of all the plurality of sectioned areas included in the setting range.

6. The vehicle traveling condition evaluation method according to claim 1, wherein, in the calculating, the index value is corrected based on traveling-related information indicating a traveling-related matter that affect tire wear as a result of traveling of the vehicle.

7. A vehicle traveling condition evaluation system comprising:
a reception unit that detects position information indicating a position of a vehicle;
a measurement unit that measures traveling information indicating traveling of the vehicle;
a storage unit that stores map information, a plurality of sectioned areas obtained by dividing a map displayed on a screen based on the map information, and the position information and the traveling information associated with each other;
a display unit that displays a map based on the map information stored in the storage unit; and
a processing unit that calculates an index value for each of the plurality of sectioned areas based on the position information and the traveling information stored in the storage unit, and causes the display unit to display the calculated index value as traveling severity in the map displayed on the display unit based on the position information detected by the reception unit.

8. The vehicle traveling condition evaluation method according to claim 2, wherein, in the displaying, the index value of the traveling information calculated for each of the plurality of sectioned areas in the calculating is identifiably displayed as the traveling severity on a road contained in the map displayed on the screen.

9. The vehicle traveling condition evaluation method according to claim 2, wherein, in the dividing, the plurality of sectioned areas are managed for each country.

10. The vehicle traveling condition evaluation method according to claim 2, wherein, in the dividing, an index value for a setting range larger than each of the plurality of sectioned areas is calculated based on the index value for each of all the plurality of sectioned areas included in the setting range.

11. The vehicle traveling condition evaluation method according to claim 2, wherein, in the calculating, the index value is corrected based on traveling-related information indicating a traveling-related matter that affect tire wear as a result of traveling of the vehicle.
